(19) United States
(12) Patent Application Publication
(10) Pub. No.: US 2023/0249205 A1
(43) Pub. Date: Aug. 10, 2023

(54) METHODS AND SYSTEMS FOR DISPENSING SPRAY WAX AND BREAK STRIP EXTRUSIONS

(71) Applicant: Canon Virginia, Inc., Newport News, VA (US)

(72) Inventors: David M. Rumery, Newport News, VA (US); Amanda H. Thurn, Plantation, FL (US); William J. Salerno, Williamsburg, VA (US); Matthew T. Sacksteder, Virginia Beach, VA (US)

(21) Appl. No.: 18/013,353

(22) PCT Filed: Jun. 30, 2021
(86) PCT No.: PCT/US2021/039894

§ 371 Date: Dec. 28, 2022

Related U.S. Application Data
(60) Provisional application No. 63/046,518, filed on Jun. 30, 2020.
(60) Provisional application No. 63/049,475, filed on Jul. 8, 2020.

(51) Int. Cl. B05B 9/00; B05B 13/04; B05D 1/02; B22C 7/02

(52) U.S. Cl. CPC B05B 9/005; B05B 9/002; B05B 13/0431; B05D 1/02; B22C 7/02; B05D 2501/10

(57) ABSTRACT

The present disclosure relates to provided methods and systems comprising a hot melt machine having a heated hose connected to a heated dispensing gun. The present disclosure also provides a method and system for automating the creating and joining break strips.

### PRIORITY AND INCORPORATION BY REFERENCE

The present application claims priority to U.S. Provisional Pat. App. Serial Nos. 63/046,518, filed Jun. 30, 2020, and 63/049,475 filed Jul. 8, 2020, the disclosure of each of which is incorporated herein by reference in their entirety.

### TECHNICAL FIELD

The present disclosure relates to methods and devices for use in the automated assembly and/or preparation of wax molds usable in lost wax casting.

### BACKGROUND

The casting of metal objects using a lost wax process is an ancient and well-known process that is still widely used in areas including the manufacture of jewelry, dentistry, the arts, and industry. When used for industry, lost wax casting may also be referred to as investment casting, and is commonly used in engineering and manufacturing applications to create precision metal parts.

Traditionally, lost wax casting is a manual process; the wax molds are assembled by hand, which is a labor-intensive, time-consuming operation and allows for a high degree of variation in part placement. An operator would gather all of the necessary parts and then start the assembly process. Using templates, hot irons, melted wax and other methods they would assemble the molds’ multiple parts following the work standards for the specific wax mold. During the assembly process, an operator would have to place each part in its specific location, customizing multiple parts to fit by trimming and melting to size, then placing them in the desired location.

To verify that each part on the wax mold meets the finished product’s quality requirement the wax mold is then transferred to an inspection station. At the inspection station, the operator manually verifies each part and its supporting structures position by sliding a template over each part/structure one at a time, rotating the wax mold’s assembly to verify each location.

The steps in lost wax casting include those found in FIG. 1, namely wax injection, pattern assembly, shell making, de-waxing, metal pouring, and shell removal, resulting in a finished product. In this process a wax mold is dipped in a ceramic slurry which hardens to form a ceramic shell (shell making). The wax mold is constructed by assembling wax parts in the form of a weldment. These parts are created through injection molding, 3d printing, or other (usually additive) manufacturing methods. These solid wax parts are welded (fused) together by hand using a hot iron, molten liquid wax, or a combination of both.

The shell is then heated and wax is removed (de-waxing). The next step in the process is normally metal pouring, but it sometimes is necessary to perform additional preparation of the shell prior to metal pouring (shell prep), which can include the intentional fracturing and removal of portions of the ceramic shell.

During shell prep, it is possible for a shell to fracture in an unexpected way which may lead to damage or complete loss of the shell. To help prevent this issue, a break strip feature is added to the pattern assembly. The break strip is a bar, ring, or zig-zag shape feature that provides a fault line in the shell which aids in shell prep and prevents cracks from propagating into undesired areas of the shell.

Break strips are components that are typically injection molded and manually assembled to the pattern assembly. This requires additional time, manpower, processes, tooling, and materials.

Attempts to automate this process requires precise accuracy of its component parts and each step of the process, including placement and welding of the mold parts, as well as measurements and inspection of the mold.

Wax molds assembled for the lost wax process typically utilize melted wax and eye droppers to dispense wax on or between components and or substrates. The wax is melted using a Hot Plate and Tin Pan or Hot Pot by setting the temperature of the Hot Plate or Hot Pot to the melt point temperature of the particular wax to be used.

This process requires an operator to insert the eye dropper into the melted wax and siphon up the wax into the eye dropper. The operator dispenses the wax onto the desired surface by depressing the bulb of the eye dropper to release the desired amount of wax manually (FIG. 6).

The process of using eye droppers and melted wax is not feasible for an automated Wax Mold Assembly Process. An operator siphoning and dispensing wax manually using an eye dropper does not fit within the scheme of an Automated Wax Mold Assembly Cell Process. Additionally, manually applying wax to the components and substrates has substantial variation between operators and between sequences.

The automation of break strips requires an extra component (the break strip) that must be created by injection molding, cut from a longer piece, or by other means. To create the break strip itself requires additional cost (time, manpower, processes, tooling, and materials, handling). It is also required that the break strip is manually attached to the pattern assembly.

The small size, long shape, and flexible nature of the break strip make it difficult to handle with automation. Also, it is not feasible to automate the eyedropper welding process.

### SUMMARY OF THE DISCLOSURE

According to aspects of the present disclosure, there is provided methods and systems comprising a hot melt machine having a heated hose connected to a heated dispensing gun.

According to other aspects of the present disclosure, there is provided a method and system for automating the creating and joining break strips to a shell, pattern, or pattern assembly plate.

These and other embodiments, objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

The accompanying drawings, which are incorporated herein and form part of the specification, illustrate various embodiments, objects, features, and advantages of the present disclosure.

FIG. 1 depicts a process diagram of the investment casting process.

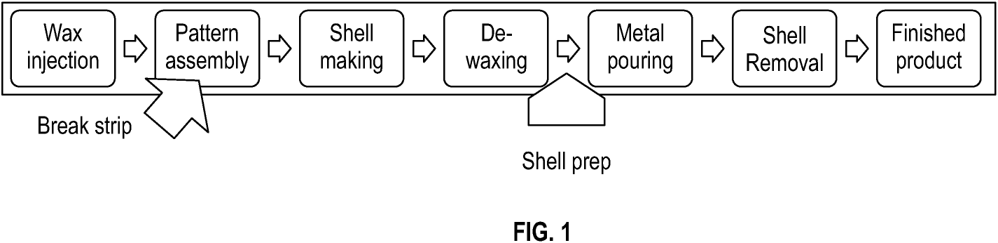

FIG. 2 depicts a hot melt machine.

FIG. 3 depicts a heated hose.

FIG. 4 depicts a heated dispensing gun.

FIG. 5 depicts the components of the present system.

FIG. 6 depicts the manual application of a break strip to a pattern assembly plate.

FIG. 7 depicts the automated application of a break strip to a pattern assembly plate.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENT

Exemplary embodiment(s) of the present disclosure will be described in detail below with reference to the accompanying drawings. It is to be noted that the following exemplary embodiment(s) are merely examples for implementing the present disclosure and can be appropriately modified or changed depending on individual constructions and various conditions of apparatuses to which the present disclosure is applied. Thus, the present disclosure is in no way limited to the following exemplary embodiment(s).

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

In one embodiment of the present disclosure, there is provided a method of dispensing spray wax comprising providing a wax dispensing system comprising a hot melting machine and a heated dispensing gun, wherein the hot melting machine and the heated dispensing gun are connected via a heated hose; opening a solenoid valve to start a flow of wax from the hot melt machine; dispensing the wax from the heated dispensing gun; and closing the solenoid valve to stop the flow of wax.

In certain embodiments, the heated dispensing gun is removably attached to a distal end of a robot arm. A programmable logic controller (PLC) can be configured to open and close the solenoid valve, wherein the PLC opens the solenoid valve for a pre-determined amount of time, wherein the same amount of wax is dispensed over multiple dispensings.

In other embodiments, the heated dispensing gun comprises a nozzle having needle retraction and extension, which can provide binary control of wax dispensing. When the needle is retracted, wax dispensing is stopped; wax dispensing occurs only when the needle is extended.

In further embodiments, the melted wax maintains about the same temperature while it travels via the heated hose from the hot melt machine to the heated dispensing gun.

According to one embodiment of the present disclosure, there is provided a spray wax dispensing system comprising a hot melting machine and a heated dispensing gun, wherein the hot melting machine and the heated dispensing gun are connected via a heated hose; a solenoid valve to start and stop a flow of wax from the hot melt machine; wherein a programmable logic controller (PLC) causes the opening and closing of the solenoid valve; and a proportional-integral-derivative (PID) controller which is configured to control the temperature of the hot melting machine, the heated hose and the heated dispensing gun.

In certain embodiments, the system is used in conjunction with an automated robotic system, and the heated dispensing gun of the system can be attached (removably or not) to a distal end of a robot arm. Said robot arm can be in communication with a controller that directs the movement of the arm and the control of the heated dispensing gun.

In another embodiment, there is provided a system comprising a hot wax spray applicator which is attached to a distal end of a robotic arm. In certain embodiments, the hot wax spray applicator can be a heated dispensing gun.

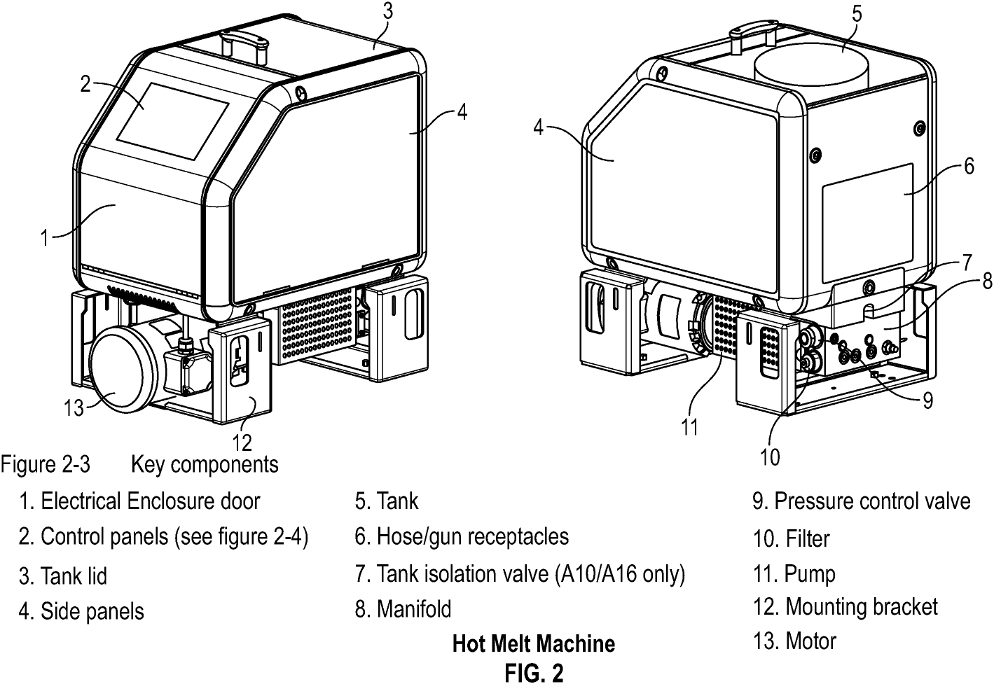

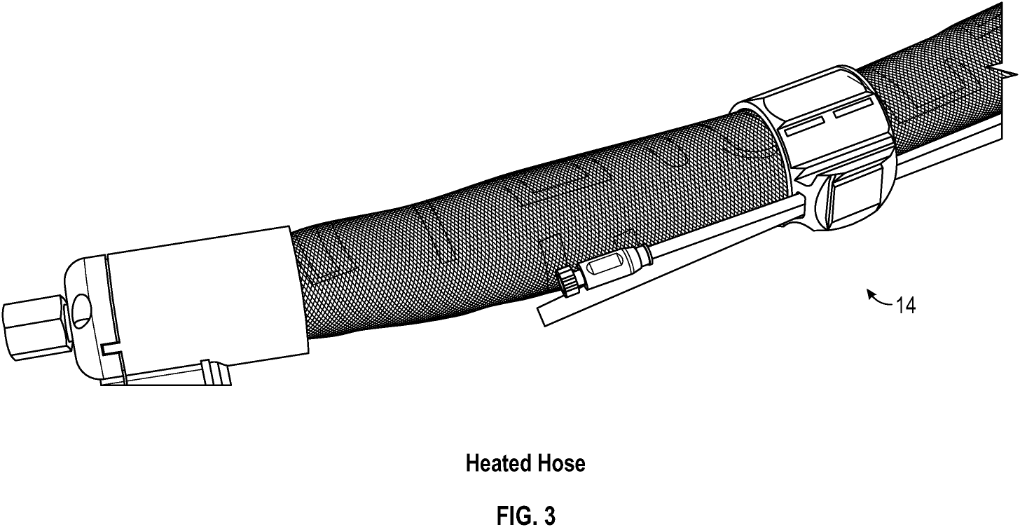

As shown in FIG. 2, an exemplary hot melt machine is depicted which is typically used for hot melt wax applications. An exemplary hot melt machine comprises an electrical enclosure door 1, a control panel 2, tank lid 3, side panels 4, tank 5, hose/gun receptacles 6, tank isolation valve 7, manifold 8, pressure control valve 9, filter 10, pump 11, mounting bracket 12 and motor 13. It is within the scope of the present disclosure that other similar or different models of melting machines can be used within the present disclosure. To enable automation of wax dispensing, a wax melting machine is set up to melt and control the temperature of an appropriate wax to a liquefied state. In one embodiment, the machine is fitted with a proportional-integral-derivative (PID) control to control the temperature of the wax in the tank 5, along with a heated hose 14 (shown in FIG. 3) and a heated dispensing gun 15. The use of a heated hose 14 and heated dispensing gun 15 allow for better control of the temperature of the melted wax, and provides a more consistent temperature. The pump 11 controls the flow of wax as demanded to the heated hose 14 and heated gun 15.

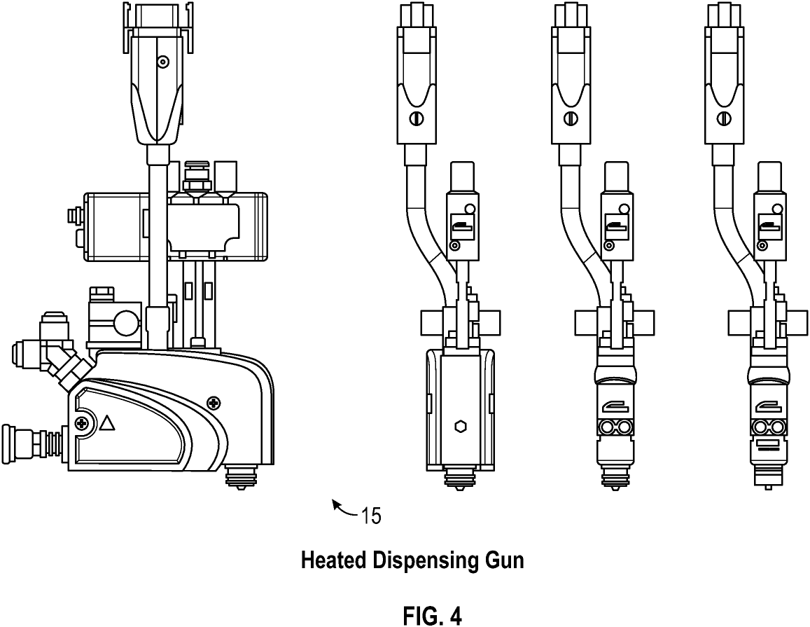

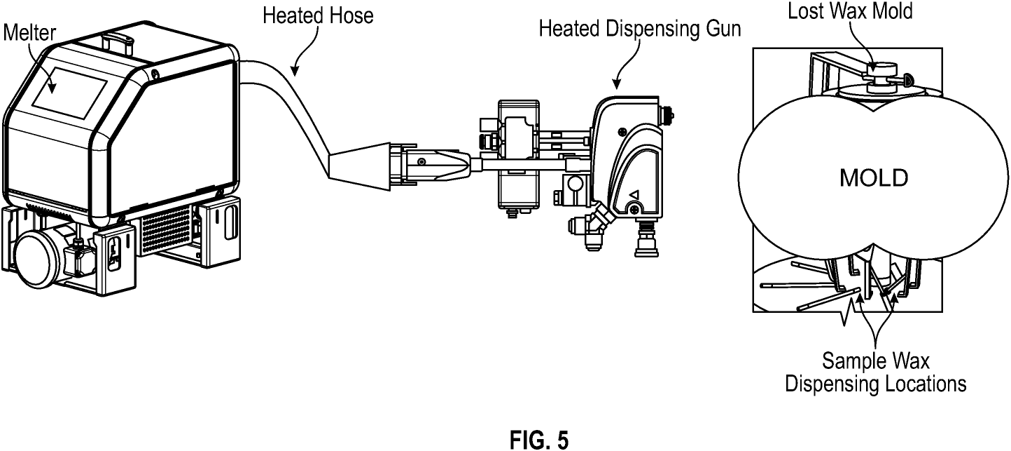

The heated dispensing gun 15 shown in FIG. 4 is actuated by a Programmable Logic Controller (PLC) 16. A solenoid valve can be opened and closed to start and stop the flow of wax from the melting machine through the heated hose 14 and heated dispensing gun 15. The heated dispensing gun 15 can be maneuvered by and the position controlled by, an end of arm tooling attachment to a robot in an automated system, in some embodiments, the robot may be a 6-axis robot. An exemplary system according to the present disclosure is provided in FIG. 5, which can include a melting machine in fluidic communication with a heated hose 14, which in turn is in fluid communication with a heated dispensing gun 15. The heated dispensing gun 15 can then be used in an automated system to apply melted wax during the process of preparing wax molds for use in an investment casting process.

In one embodiment, a system comprising a heated hose and heated dispensing gun, and methods for dispensing wax using the same provide significant advantages when used in preparing molds for use in lost wax molding. A greater repeatability and accuracy in the placement of melted wax on components and/or mold substrates is provided by the disclosed system and method. In one embodiment, the PLC control ensures that the same amount of wax is dispensed each time the solenoid is actuated, increasing repeatability and reducing variability between successive uses. Increased repeatability of the location of the wax placement is provided by use of the disclosed system and method with an automated system that comprises robotic controls such as a 6-axis robot control.

In an embodiment of the present disclosure, there is greater control of the temperature of the wax through the PID temperature control than wax in an uncontrolled system such as when wax is manually applied via an eye dropper. In certain embodiments, the heated dispensing gun 15 has improved on/off control through needle extension and retraction into the nozzle tip, which provides binary control of the wax dispensing without dripping and stringing of the wax, which is an improvement over off the shelf wax dispensing equipment.

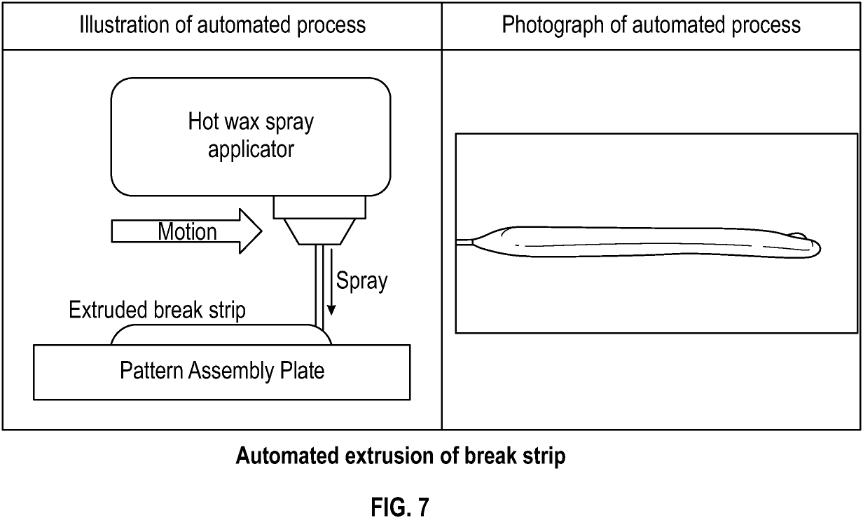

In a further embodiment, the system and method for dispensing wax through a heated dispensing gun and a heated hose can be utilized for improving systems and processes for use in lost wax casting such as for the automated extrusion of break strips, as depicted in FIG. 7.

In a further embodiment, there is provided a method for creating a break strip comprising providing a hot wax spray applicator; moving the hot wax spray applicator across a surface while extruding wax in a pre-determined location for a predetermined amount of time to create a break strip.

In certain embodiments, the method includes providing an automated system, wherein the hot wax spray applicator can be attached to a distal end of a robotic arm, which robot arm can be in communication with a controller that directs the movement of the arm and the control of the hot wax spray applicator. Such controller can cause the robotic arm to activate the hot wax spray applicator to extrude the wax. Further, the robotic arm can manipulate the hot wax spray applicator such that it extrudes wax in a pre-defined pattern at the pre-determined location, thereby creating a break strip.

In other embodiments, the system and method provide a controlled temperature for the wax, wherein the wax temperature is approximately the same from the tank through the heated hose and into the hot wax spray applicator. The disclosed system and method additionally provide for controlled pressure of the wax during extrusion. In certain embodiments, the hot wax spray applicator is a heated dispensing gun.

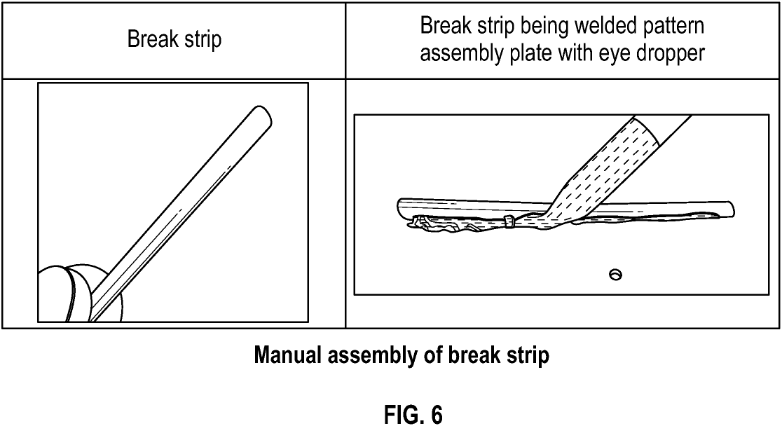

In traditional usage, a break strip is extruded, and then separately attached to desired location via the application of melted wax, for instance by an eye dropper, as shown in FIG. 6. In one embodiment, the system and method of the present disclosure comprises a hot wax spray applicator such as a heated dispensing gun which is moved across a desired surface, including the surface of a pattern assembly plate, and which extrudes a break strip of the desired shape, size and position. In other embodiments, the system and method for break strip extrusion allows for the automated control of the wax temperature and pressure, along with the automated positioning of the wax extrusion. In such embodiments, the hot wax spray applicator is controlled by an automated system, include being maneuvered by and the position controlled by, an end of arm tooling attachment to a robot in an automated system, in some embodiments, the robot may be a 6-axis robot. In other embodiments, the wax dispensing system and methods of using same as previously described can be implemented in order to dispense a break strip.

It is a facet of the presently disclosed system and method that the creation of a separate part that must be welded to the pattern assembly is not required; thereby the present system and method avoid all of the associated manpower and tooling costs inherent in a manual breakstrip extrusion process, although materials are still required. This system and method is easy to automate and can be incorporated into a fully automated mold assembly process.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. An I/O interface can be used to provide communication interfaces to input and output devices, which may include a keyboard, a display, a mouse, a touch screen, touchless interface (e.g., a gesture recognition device) a printing device, a light pen, an optical storage device, a scanner, a microphone, a camera, a drive, communication cable and a network (either wired or wireless).

### DEFINITIONS

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature’s relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of dispensing spray wax comprising:
providing a wax dispensing system comprising a hot melting machine and a heated dispensing gun, wherein the hot melting machine and the heated dispensing gun are connected via a heated hose;
opening a solenoid valve to start a flow of wax from the hot melt machine;
dispensing the wax from the heated dispensing gun; and
closing the solenoid valve to stop the flow of wax.

2. The method of claim 1, wherein the heated dispensing gun is removably attached to a distal end of a robot arm.

3. The method of claim 1, wherein a programmable logic controller (PLC) is configured to open and close the solenoid valve.

4. The method of claim 3, wherein the PLC opens the solenoid valve for a pre-determined amount of time, wherein the same amount of wax is dispensed over multiple dispensings.

5. The method of claim 1, wherein the heated dispensing gun comprises a nozzle having needle retraction and extension.

6. The method of claim 5, wherein the heated dispensing gun nozzle provides binary control of wax dispensing.

7. The method of claim 1, wherein the melted wax maintains about the same temperature while it travels via the heated hose from the hot melt machine to the heated dispensing gun.

8. A spray wax dispensing system comprising:
a hot melting machine and a heated dispensing gun, wherein the hot melting machine and the heated dispensing gun are connected via a heated hose;
a solenoid valve to start and stop a flow of wax from the hot melt machine; wherein a programmable logic controller (PLC) causes the opening and closing of the solenoid valve; and
a proportional-integral-derivative (PID) controller which is configured to control the temperature of the hot melting machine, the heated hose and the heated dispensing gun.

9. The system of claim 8, wherein the system is used in conjunction with an automated robotic system.

10. The system of claim 9, wherein the heated dispensing gun is removably attached to a distal end of a robot arm.

11. A system comprising a hot wax spray applicator which is removably attached to a distal end of a robotic arm.

12. A method for creating a break strip comprising:
providing a hot wax spray applicator;
moving the hot wax spray applicator across a surface while extruding wax in a pre-determined location for a predetermined amount of time to create a break strip.

13. The method of claim 12, wherein the hot wax spray applicator is attached to a distal end of a robotic arm.

14. The method of claim 13, wherein the robotic arm causes the hot wax spray applicator to extrude the wax.

15. The method of claim 14, wherein the robotic arm manipulates the hot wax spray applicator such that it extrudes wax in a pre-defined pattern at the pre-determined location.

16. The method of claim 14, wherein the wax temperature is controlled.

17. The method of claim 14, wherein the wax pressure during extrusion is controlled.

18. The method of claim 14, wherein the hot wax spray applicator is a heated dispensing gun.
